(19) United States
(12) Patent Application Publication
(10) Pub. No.: US 2012/0012213 A1
(43) Pub. Date: Jan. 19, 2012

(54) SINGLE-CONTROL MIXING VALVES FOR HOT AND COLD WATER

(76) Inventor: Giancarlo TEDOLDI, Castiglione Delle Stiviere (MN) (IT)

(21) Appl. No.: 13/183,906

(22) Filed: Jul. 15, 2011

(30) Foreign Application Priority Data
Jul. 19, 2010 (IT) BS2010A000126

(51) Int. Cl. F16K 11/00

(52) U.S. Cl. 137/625.4

(57) ABSTRACT

The invention relates to a hot and cold water mixer valve (10) comprising a fixed plate (14) having an input slot for cold water (20) and an input slot for hot water (21), a movable plate (15) able to be moved on the fixed plate by a control lever (16) and having at least one port (23) designed to communicate with one, the other or both the slots of the fixed plate, starting from the center position of closing/opening of the valve. When the control lever (16) is in the center closing position, the port (23) of the movable plate (15) is radially aligned and at a distance from the cold water input slot (20); when the control lever is in the center opening position, the port (23) of the movable plate (15) intercepts and communicates only with the cold water input slot (20) for delivering cold water only.

### FIELD OF APPLICATION OF THE INVENTION

The present invention relates generally to the field of taps and fittings and refers in particular to mixer valves for use in taps for mixing two fluids at different temperatures, particularly hot and cold water.

### STATE OF THE ART

In the field herein considered the mixing of hot and cold water can be carried out by single-handle taps provided with single-control mixing valve, also known as mixer cartridge. Typically, for its use the mixer valve is inserted into a valve body to which two pipes for supplying separately hot water and cold water are connected and having a spout of water towards usage.

According to a known embodiment, a mixer valve comprises its own cartridge body or casing having two bottom inputs for a separate input of hot water and cold water coming from the respective pipes connected to the tap body and an output opening for cold, hot or mixed water towards the spout of the tap itself. Inside the body or casing, valve means are provided that, starting from a fully closed and sealed position of the valve, allow to adjust both the flow rate and the water temperature delivered from time to time, changing the opening/closure degree of the water inputs and thus the flow of incoming hot and cold water too, for their mixing at changing ratios.

The valve means of these mixer valves are mostly of overlapping plate type, made of ceramic or other material, including a fixed input plate and a movable control plate, the latter being subjected to movements in different directions, manually operated by means of a puller driven by a control lever.

In particular, the fixed plate has input slots for water coinciding with the bottom inputs of the body or casing and the movable control plate has at least one port being able to be positioned in no way, partly or fully at the openings of the fixed plate and communicating downstream with the output opening towards the tap spout.

Usually, a mixing valve is accommodated in a valve body in a precise, unique position with respect to the inputs of hot and cold water. For this purpose the cartridge casing is provided with a pair of pins designed for engagement in seats obtained on the bottom of the tap or faucet body.

In addition, the opening/closing of such a mixer valve is carried out with an oscillating movement of the control lever around an axis of oscillation in a plane parallel to the plane of the movable plate for a translating movement thereof on the fixed plate, whereas the adjustment of the mixing is carried out by rotating the lever around a vertical axis and corresponding rotations of the movable plate on the fixed plate. More precisely, in almost all cases, in one rest position the control lever is located in a center position. Starting from this position and after the valve has been opened by an oscillation of the lever upwards: to a full rotation of the lever to the right corresponds a delivery of only cold water; to a full rotation of the lever to the left corresponds a delivery of only hot water; and to a movement of the lever between these two extreme positions corresponds a delivery of both cold and hot water mixed in different ratios depending on the position of the lever.

However, starting from the closed valve, especially when its control lever is in the rest center position, the next opening step would cause a completely unintentional delivery of mixed water with consumption albeit partial, but disadvantageous, of hot water. Consequently, it would also activate a water heating system, such as a boiler, an instant boiler or a heat exchanger, in any case with an evident energy consumption.

In an attempt to compensate for this problem, the document EP 1 064 481 B1 h as proposed a tap incorporating a mixer valve of the above referred type, but with the characteristic that the puller associated with the movable control plate is orientated and guided to form an angle different from 90° between the direction of movement of said plate and the axis of rotation of the control lever. This embodiment, however, entails a change in the component arrangement from the usual, at least a specific working of the puller to be coupled with the movable plate in accordance to the teachings of such a document.

It was also proposed to modify the placement and angular orientation of the mixer valve in a respective valve body which, however, involves a change in the arrangement of pins of the cartridge casing or a different working of the tap body at least regarding coupling seats with these pins and the arrangement of the input passages for hot and cold water.

### OBJECTS AND SUMMARY OF THE INVENTION

On the contrary, an object of the present invention is to create conditions to limit unnecessary delivery of hot water through a mixer valve and thus to achieve energy savings, but without requiring any changes in coupling between the mixer valve and a respective valve tap and without any change in the coupling between the movable plate and the corresponding puller as well.

Another object of the invention is to propose a mix er valve adapted to effectively limit the consumption of hot water and being able be used with any tap body in place or substitution of conventional mixer valves of the type having the characteristics reported above.

A further object of the present invention is to propose a mixer valve by which, starting from a closed position, a delivery of hot water is possible only with voluntary movements by the user, in the absence of which only cold water will be delivered. In other words, only voluntarily a user will be able to deliver hot or mixed water at the desired temperature.

Such objects and resulting implicit advantages are achieved with a mixer valve for hot and cold water according to claim 1, wherein the movable control plate driven by the control lever through the puller, in the center closed position, it is at the cold water input slot and intercepts only it.

### BRIEF DESCRIPTION OF THE DRAWINGS

More details of the invention will be apparent, however, from the following the description made with reference to the attached drawings, for illustration only and not limiting, wherein:

FIG. 1 is an exploded view of the components of the mixer valve according to the invention;

FIG. 2 is a section view of mixer valve when assembled;

FIGS. 3 and 4 show respectively the plan view of a fixed input plate and a movable control plate;

FIG. 5 shows the two fixed and movable plates overlapped with the movable plate in a center and fully closed position of the passages for water, either cold or hot;

FIG. 6 shows a view similar to that in FIG. 5, but with the movable plate in a center position and partially opening the passage for cold water only;

FIG. 7 still shows a view of the two overlapped plates, but with the movable plate in the fully open position for the passage of cold water only;

FIG. 8 shows the movable plate rotated over the fixed plate to a position for delivering mixed hot and cold water; and

FIG. 9 shows the movable plate rotated over the fixed plate to a position for delivering hot water only.

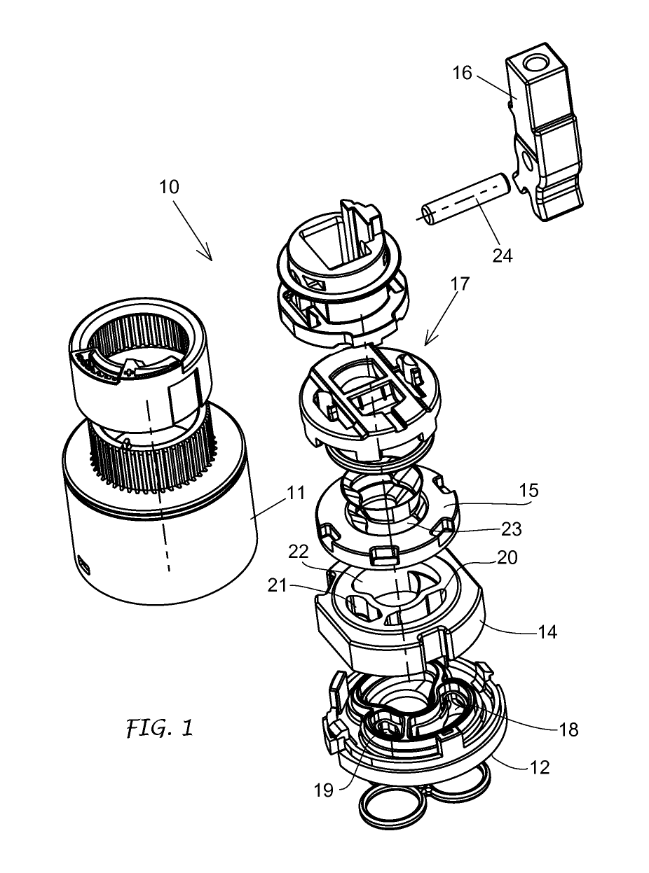

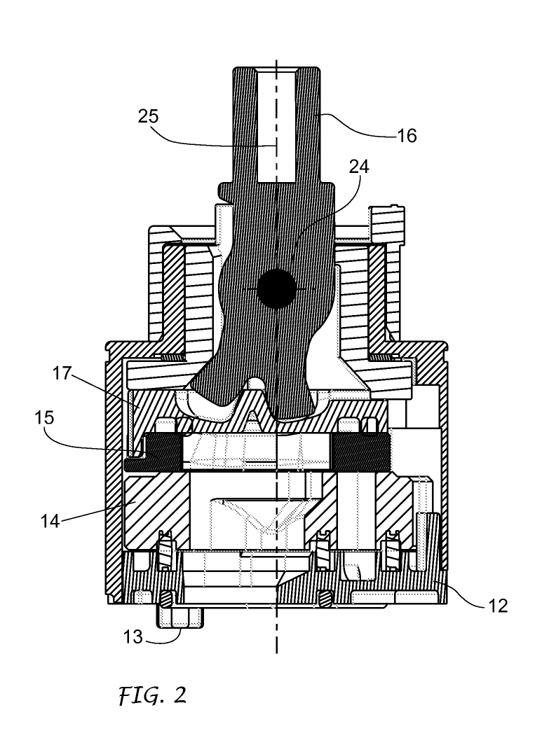

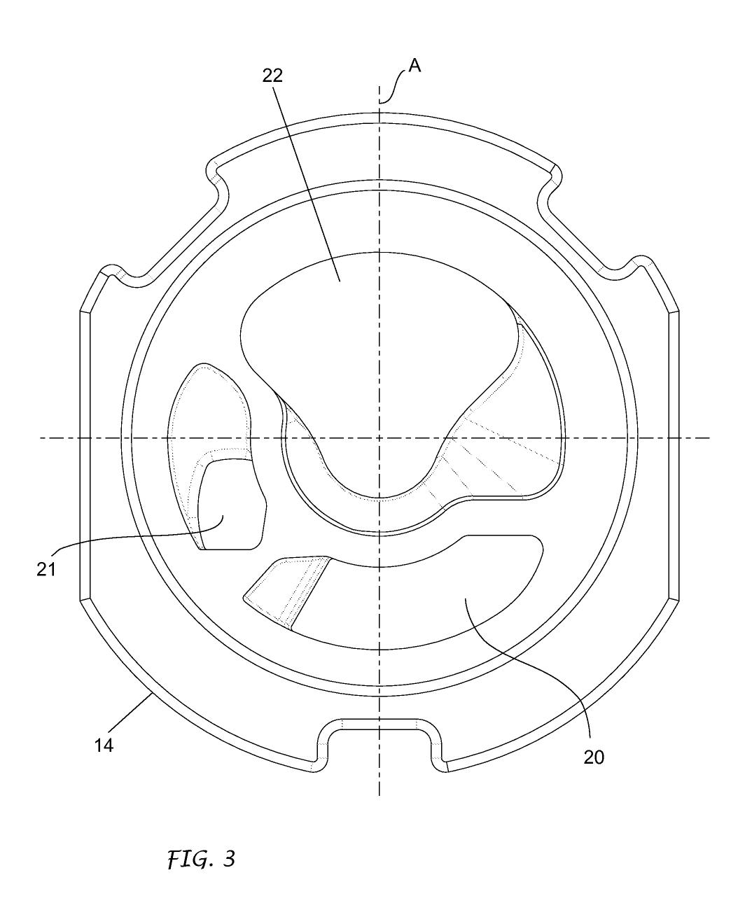

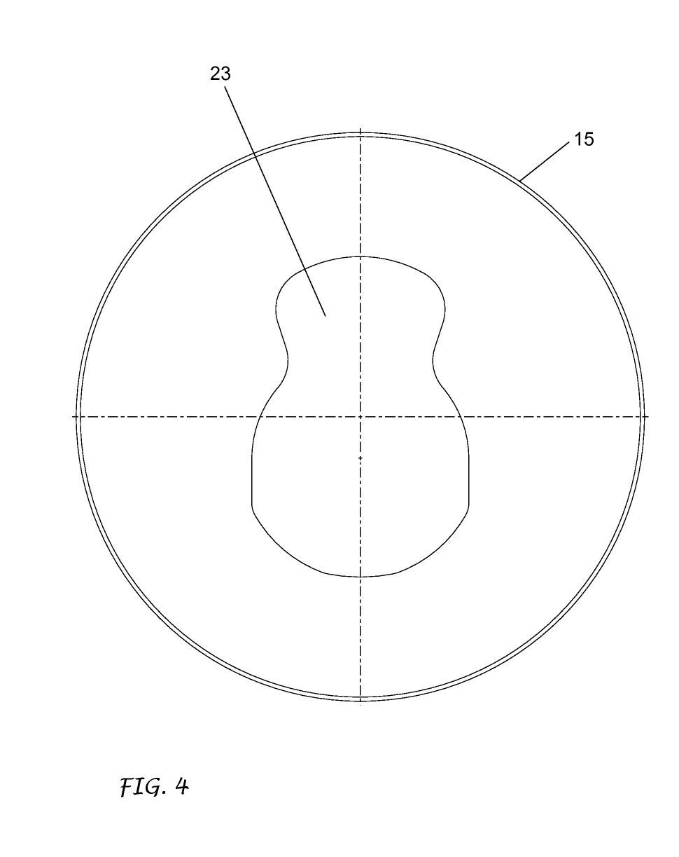

In said drawings a mixer valve 10 is represented according to the invention, designed to be inserted and locked, by means of interposed gaskets, in a tap body—not represented.

### DETAILED DESCRIPTION OF THE INVENTION

The valve comprises a cartridge casing 11 having a bottom wall 12 with positioning pins 13 in the tap body.

In said casing 11 valve means are provided, comprising two overlapped plates, made of ceramic or other material, including a fixed input plate 14, resting on the bottom wall 12 with the interposition of gaskets, and a movable control plate 15, rested and movable on the fixed plated, and a control lever 16 associated with the movable plate by an interposed puller 17.

On the bottom wall 12 of the cartridge casing 11 two input passages 18, 19 are provided for supplying cold and hot water separately from respective pipes connected to the tap body.

The fixed plate 14 has two arched slots 20, 21, respectively, for cold water input and hot water input coincident with said bottom input passages 18, 19, and an output slot 22 for mixed water.

According to the invention the input slots 21, 20 for hot and cold water have different angular size, with the cold water input slot 20 larger than the other.

Moreover, the two slots are angularly arranged in an asymmetric position with respect to the diametric axis A of the fixed plate 14. In particular, the cold water input slot 20 is placed astride the axis A of the fixed plate 14 so as to be on the directrix of the control lever when the latter is in a center closed/open position, while the hot water input slot 21 is laterally moved compared to the axis itself.

The movable plate 15 has at least one center port 23 that, as a consequence of the plate rotation itself, is positioned far away or, selectively, partially or fully coinciding with one or both input slots 20, 21 for hot and cold water of the fixed plate and at the other side communicates with an output duct for the water passing longitudinally through the puller 17, in its turn communicating with the spout—not shown—connected to the latter.

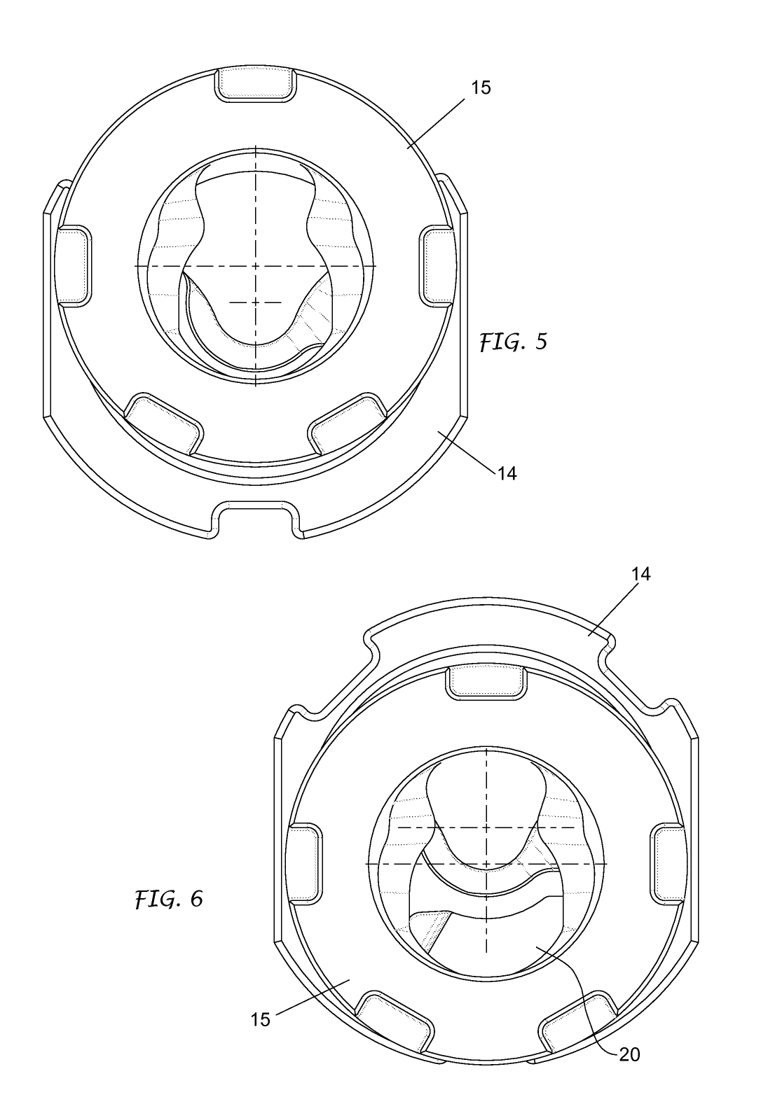

The movable plate 15 is capable of translation and rotation on the fixed plate 14 and therefore the control lever 16 is mounted and oscillating on a transversal pivot 24, to control the movements of translation of the movable plate, and is rotating around an axis 25 perpendicular to the bottom of the body, to cause the rotation of the same plate. In fact, the oscillating movement of the control lever causes a transfer movement of the movable plate 15 on fixed plate 14 between a closed position—FIG. 5—wherein the port 23 of the fixed plate is at a distance from the slots 20, 21 of the fixed plate to an open position resulting, respectively, in the opening/closing of the mixer valve. Thanks to the particular configuration and slots position, in the open position—FIG. 6—the port 23 intercepts at least part of the cold water input slot 20, whereas it is at a distance from the hot water input slot 21 thereby determining the cold water delivery only.

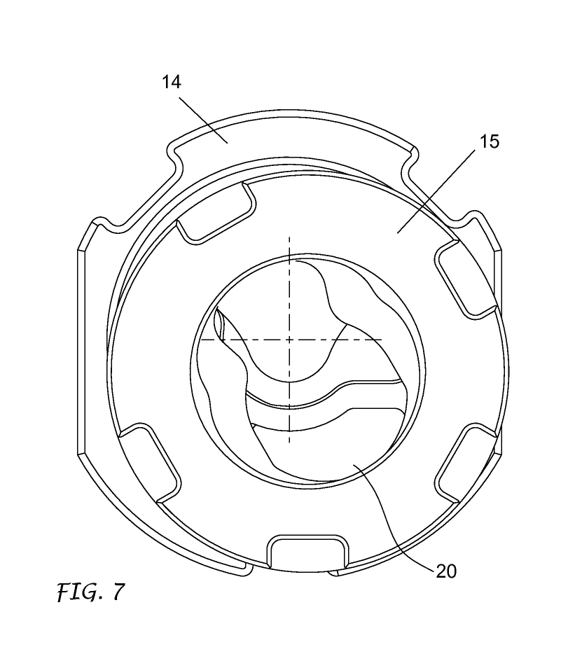

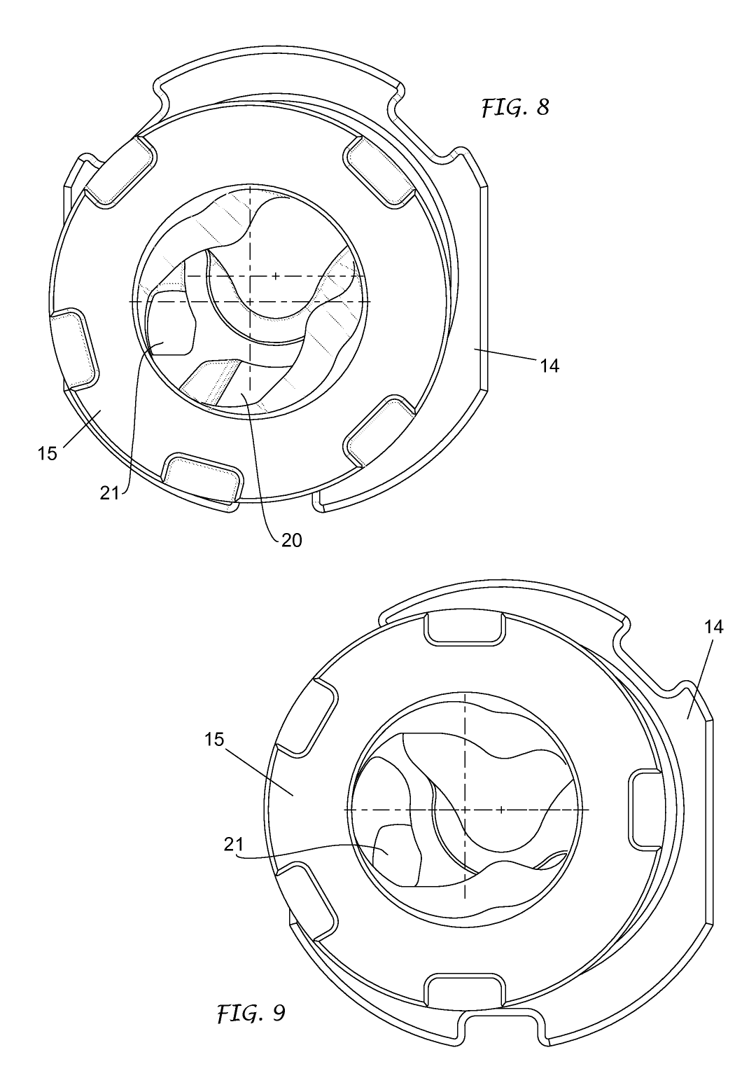

The rotation of the lever, on the contrary, allows to adjust the water temperature. More precisely, starting from the center position, the partially or whole rotation on one side, usually the right—FIG. 7—causes a rotation of the movable plate 15 such that the port 23 is still at the cold water input slot 20 only, with a consequent delivery of cold water; always starting from the center position the partial rotation on the other side, usually the left—FIG. 8—causes a rotation of the movable plate such that the port 23 is also at least partially at the hot water input slot 21—FIG. 8—with a delivery of mixed water, whereas the total rotation causes a rotation of the movable plate 24 such that the port 24 intercepts the hot water input slot 21 only—FIG. 9—resulting in a hot water supply.

Thus, because of the arrangement of hot water input slot 21, the delivery of hot water can not happen accidentally when opening the tap, but only voluntarily by an user as a consequence of a rotation of the control lever compared to the open position, thus avoiding unnecessary wastage.

The real mixing angle of 90° to the left from the center position (open valve and delivery of cold water only) meets the respective regulations in force (EN NF 817). However, an angle of rotation to the right was also set up, in the illustrated example of 30°, without changing temperature and flow rate of the delivered cold water, to give a feeling of normal use of the mixer valve (with the usual movements of the lever both to the right and to the left from center position).

This cartridge allows to obtain savings of hot water, changing only the arrangement of the water passages in the slots/port of the plates and in the bottom wall, without the need to change other components relatively to used standard to date.

1. A hot and cold water mixer valve comprising a cartridge casing, a fixed input plate in said casing provided with an input slot for cold water and an input slot for hot water, a moveable control plate subject to transfer and rotation movements on said fixed plate and having at least a port partially or totally positionable in line with one, the other or both slots of the input plate, and a control lever to control said transfer and rotation movements of the moveable plate by means of a puller starting from a closed/open central position of the valve, wherein, with the control lever in the central closed position, the port of the moveable control plate is radially aligned and at a distance from the cold water input slot of the fixed input plate, and with the control lever in the central opening position, the port of the moveable control plate is designed to intercept and communicate only with the cold water input slot of the fixed input plate so as to deliver only cold water.

2. A mixer valve according to claim 1, wherein the cold water input slot has larger angular dimensions compared to the input slot for hot water.

3. A mixer valve according to claim 1, wherein the cold water input slot is positioned astride a diametric axis of the fixed plate basically parallel to the directrix of the control lever when the latter is in a central closed/open position.

4. A mixer valve according to claim 1, wherein the cold water input slot and the hot water input slot are placed at an angle in an asymmetric position compared to said diametric axis of the fixed plate.

5. A mixer valve according to claim 4, wherein the hot water input slot is completely on one side compared to said diametric axis.

6. A mixer valve according to claim 1, wherein, starting from the central opening position, to a partial or total rotation in an anticlockwise direction of the control lever, the port of the moveable plate is in communication only with the cold water input slot, whereas following a partial or complete clockwise rotation of said control lever, the port of the moveable plate is designed to partially communicate both with the cold water input slot and the hot water input slot or only fully with the hot water input slot, so as to deliver either mixed water or only hot water, respectively.

7. A mixer valve according to claim 6, wherein, starting from the center position the control lever is subject to an anticlockwise rotation at a lower angle compared to the rotation angle of said lever moving in a clockwise direction.

8. A mixer valve according to claim 7, wherein when starting from the center position, the rotation angle of the control lever to deliver only cold water is a bout 30° and the rotation of the control lever in the opposite direction to deliver either mixed water or only hot water is about 90°.

9. A mixer valve according to claim 2, wherein the cold water input slot is positioned astride a diametric axis of the fixed plate basically parallel to the directrix of the control lever when the latter is in a central closed/open position.

10. A mixer valve according to claim 2, wherein the cold water input slot and the hot water input slot are placed at an angle in an asymmetric position compared to said diametric axis of the fixed plate.

11. A mixer valve according to claim 3, wherein the cold water input slot and the hot water input slot are placed at an angle in an asymmetric position compared to said diametric axis of the fixed plate.
